(19) United States
(12) Patent Application Publication
(10) Pub. No.: US 2004/0011480 A1
(43) Pub. Date: Jan. 22, 2004

(54) Expandable screen door

(76) Inventor: Peter Charles Andre de la Porte, Grafton, OH (US)

Correspondence Address: Peter Andre de la Porte, 11765 Castleton Lane, Grafton, OH, 44044, US

(21) Appl. No.: 10/128,549

(22) Filed: Apr. 22, 2002

(51) Int. Cl. E06B 3/12; A47H 1/00

(52) U.S. Cl. 160/232; 160/238

(57) ABSTRACT

the expandable screen door comprises of a minimum of two and up to an unlimited amount of screen sections (18, 19,20 & 15,16,17). Each with either a hook or loop, or magnet, or other fastener attached to one side of the top of the screen (12) (8), and the opposite or attracting hook, loop or other fastener, attached on the opposite top side of the screen (14) (9). The middle part of each screen section (7) consists of a flexible ventilating screen or netting material. A flexible and heavier piece of material that can be folded, rolled up or cut, is attached to the bottom part of the screen (10).

All individual screen sections can be attached at the top of the door opening (11), in a almost unlimited variety of side by side and, or overlapping configurations, limited only by the amount of screen sections used Each individual screen section can also be adjusted in height, by either folding up the bottom weighted flexible material (10), or by cutting it to fit the opening height.

### CROSS REFERENCE TO RELATED APPLICATIONS

Not applicable

### BACKGROUND

1. Field of invention

This invention relates to flexible screen doors that can be made to fit many different size door openings.

2. Description of Prior Art

Screens are commonly used in door, and window openings of industrial, commercial, medical and residential buildings. They offer ventilation and keep most insects and birds out. Originally these screens had to be measured exactly or even custom ordered to fit the exact sizes of door and window openings. This is inconvenient because most door and window openings are of different sizes. Resellers and dealers have to keep several sizes of screens and screen doors in stock. This is expensive because it increases inventory. This invention would be advantageous to dealers because they can sell individual screen section to custom make a specific need Inventors created several type of screens that are attached to or around the door or window opening with hook and loop configuration. U.S. Pat. No. 4,249,589 to Loeb (1981) discloses a screen that installs around the window opening with hook and loop fasteners. In the “do it yourself” kit, it shows how it can be cut to fit one opening exactly; however, once cut to fit one particular opening, they no longer will fit in a larger opening. Additionally, for traffic to pass through this door, you have to separate the Velcro and remove and reattach most of the screen.

U.S. Pat. No. 4,874,028 to Carol J.Lynch and Debbie Corday discloses a screen that is detachable while using spring loaded tension rod. Even though its basic design would allow it move it to slightly narrower door openings that it was designed for, you would have to bunch up the screen like a curtain, it would look very unattractive, and it would only be practical in very small differences in width.

In addition when passed through, it uses Velcro pieces to keep closed. Unless you line them up perfectly every time after you pass through, they could leave gaps for insects to travel through.

All the screen doors and windows heretofor know suffer from a number of disadvantages:

(a) There are many sizes of door and opening widths. At present all screen doors have to be specifically designed to fit certain width door openings. Therefore you can only move them from one size opening width to a very limited amount of different size opening widths.

(b) At present if a screen is damaged, expensive time consuming repairs or even complete abandonment are the only options.

(c) The only self closing systems available are bulky and expensive.

### BRIEF SUMMARY OF THE INVENTION

In accordance with the present invention, the expandable screen door comprises of a minimum of two and up to an unlimited amount of screen sections, each with either a hook or loop, or magnet, or other fastener attached to one side of the top of the screen, and the opposite or attracting hook, loop or other fastener, attached on the opposite top side of the screen. The middle part of each screen section consists of a flexible ventilating screen or netting material. A flexible and heavier piece of material that can be folded, rolled up or cut, is attached to the bottom part of the screen.

All individual screen sections can be attached on top of the doorway, in a almost unlimited variety of side by side and, or overlapping configurations, limited only by the amount of screen sections used. Each individual screen section can also be adjusted in height, by either folding up the bottom weighted flexible material, or by cutting it to fit the opening height

### OBJECTS AND ADVANTAGES

Several objects and advantages of the present invention are:

(a) To provide a screen door that be installed to virtually any door or opening width, just by adding or subtracting individual screen sections.

(b) To provide a screen door that exists of individual and independent sections.

(c) When damaged, only the individual screen section that is damaged needs to be replaced.

(d) To provide a screen door that can be installed and moved very quickly and with ease.

(e) To provide a screen door that is self closing after passing through it.

(f) To provide a screen door that can cover any width opening by adding, moving or subtracting individual trips.

(g) To provide a screen door that can be installed with a minimun, or with-out the use of installation tools.

(h) To provide a screen door that can be easily removed and folded for storage.

Further objects and advantages are to provide a ventilating screen door that will fit onto any width opening, only limited by the amount of screen sections used, and can be adjusted and moved to fit several different sizes height of openings, with a minimum use of no use of tools. It can be folded for storage.

The screens are weighted on the bottom, gravity will force them back into its original straight and closed position, so it is self closing when forced out of the hanging straight position.

Still further objects and advantages will become apparent from a consideration of the ensuing description and drawings.

Screen sections can be spaced at will and placed individually and on top of each other. The bottom is weighted for better closure and can be adjusted rolled up r cut to fit several sizes of door opening.)

### BRIEF DESCRIPTION OF THE SEVERAL VIEWS OF THE DRAWING

In the drawings,

FIG. 1 shows the frontal view of several screens sections together to make a “finished” door. The middle section is partially peeled back for a better view.

FIG. 2 shows the assembly of the individual screen Section.

FIG. 3 Shows a top view of how the strips would overlap in a wide door opening, and how the individual strips are attached to the wall above the opening

FIG. 4 Shows a top view of how the strips would overlap in a narrow door opening, and it shows how the loop and hook is attached to the screen.

### REFERENCE NUMERALS IN DRAWINGS

5 Wall

6 Opening header of the wall, where the screen-door mounts

7 Flexible mesh screen

8& 9 Hook or loop, or magnetic or other fastening device attached to one side of the screen with the opposite and attracting hook or loop, or magnetic or other fastening device, attached to the other side of the screen.

10 Flexible weighted material

11 Hook or Loop, magnetic, or other fastening device to be attached to door or opening frame or header.

12&14 Hook or loop, or magnetic or other fastening device attached to one side of the screen with the opposite and attracting hook or loop, or magnetic or other fastening device, attached to the other side of the screen

13 Top view of Flexible Screen sandwiched between fasteners

15, 16 & 17 Individual screen segment spaced in close

configuration to fit a narrow door opening

18, 19 & 20 Individual screen segment spaced in wide

configuration to fit a wider door opening

### DETAILED DESCRIPTION OF THE INVENTION

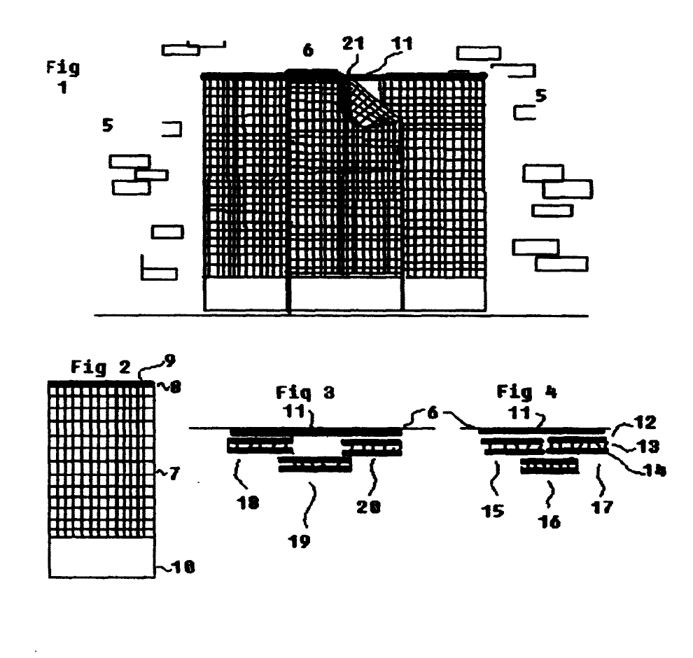

An assembled view of the present invention is illustrated in FIG. 1. The wall 5 is shown on the left and right side of the screen door. 11 shows the fastener that is attached to the wall or header 6 above the door or other opening. This fastener can be hook or loop, magnetic or other fastening device. It can be attached with self adhesive backing or with screws or nails for a more permanent attachment.

21 is a view with the middle screen section partially peeled back. It shows the pieces of hook or loop, magnetic or other fastening device that are attached to both front and back side of the top of the screen segments. They are attached, back to back with the screen sandwiched in the middle. If the properties of the fastener do not attract the same exact fastener, than the opposite of that fastener has to be attached to the other side. For instance in the case of hook and loop design, the “hook” should be attached to one side on top of the screen, with the “loop” should be attached to the other side. The final arrangement should be hook facing one way, screen in between, and loop facing the other way. FIG. 2 It shows the parts that an individual screen segments consists of 8 & 9 show the pieces of hook or loop, magnetic or other fastening device that are attached to both front and back side of the top of the screen segments. They are attached, back to back with the screen sandwiched in the middle. If the properties of the fastener do not attract the same exact fastener, than the opposite of that fastener has to be attached to the other side. For instance in the case of hook and loop design, the “hook” should be attached to one side on top of the screen, with the “loop” should be attached to the other side. The final arrangement should be hook facing one way, screen in between, and loop facing the other way. 7 shows a flexible mesh screen, made from a polymeric material such as nylon, vinyl, metals,rubber, leather, various impregnated or laminated fibrous materials, various plasticized materials, cardboard, paper, etc or fiberglass netting. These materials also are resistant to corrosion and otherwise are unaffected by long term exposure to harsh weather or sunlight. 10 Shows a flexible weighted panel that can be repeatedly folded without breaking, such as polyethylene, pvc, polypropelyne, vinyl, metals, rubber, leather, various impregnated or laminated fibrous materials, various plasticized materials, cardboard, paper, etc. FIG. 3 shows the top view of how the individual completed screen sections attaches to the fastener installed. It shows the surface of the door header 6 and the fastener 11 attached to the header. In the sample it shows three screen section 18, 19 & 20 for clarification purposes only, fewer or more strips can be used. It shows how you can space screen section 18 & 20, and how you attach 19 to overlap any gaps in the opening.

FIG. 4 shows the top view of a wider door or opening and shows the closer spacing of screen segment 15 and 17. It shows how 16 is attached to cover any gaps in the opening 12 and 13 show the pieces of hook or loop, magnetic or other fastening device that are attached to both front and back side of the top of the screen segments. They are attached, back to back with the screen 13 sandwiched in the middle. If the properties of the fastener 12 do not attract the same exact fastener, than the opposite of that fastener has to be attached to the other side 14. For instance in the case of hook and loop design, the “hook” should be attached to one side on top of the screen, with the “loop” should be attached to the other side. The final arrangement should be hook facing one way, screen in between, and loop facing the other way.

I claim:

1. Apparatus for mounting a ventilating insect barrier onto a door opening and comprising said insect barrier of several individual screen segments that can be installed side by side and, or overlapping each other whereby said insect barrier will fit a substantial array of openings of different widths.
